(19) United States
(12) Patent Application Publication
(10) Pub. No.: US 2026/0266412 A1
(43) Pub. Date: Sep. 10, 2026

(54) FLUID ISOLATION ASSEMBLY FOR ETCHING INNER SURFACE OF PIPE END

(71) Applicant: Tech Met, Inc., Glassport, PA (US)

(72) Inventor: Robert Vaccaro, Greensburg, PA (US)

(73) Assignee: Tech Met, Inc., Glassport, PA (US)

(21) Appl. No.: 19/554,985

(22) Filed: Mar. 3, 2026

Related U.S. Application Data
(60) Provisional application No. 63/767,769, filed on Mar. 6, 2025.

(51) Int. Cl. F16L 55/11

(52) U.S. Cl. CPC F16L 55/1108

(57) ABSTRACT

A device for isolating a flow of fluid within an inner region of a pipe adjacent its end is disclosed. The device seals around the outer and inner circumferential surfaces of the pipe to create an isolated inner region that can be exposed to a fluid or a gas, such as a gas used to purge residual fluids (i.e., dry the surfaces). The dimensions of the device determine both the length of the fluid-exposed region and the diameter of the pipe on which the device may be used. This device is particularly useful for applications such as cleaning, rinsing, etching the inner region of the pipe near its end, which can improve adhesive bonding when connecting two pipe ends together.

### FIELD OF INVENTION

This application claims priority to U.S. Provisional Patent Application Serial No. 63/767,769 filed Mar. 6, 2025, the contents of which are incorporated herein in their entirety.

### FIELD OF INVENTION

This disclosure generally relates to devices useful for etching the inner surface of a pipe, and more specifically to a device configured to isolate a fluid flow to a restricted region on an inner surface of the pipe.

### BACKGROUND

Pipes and tubular conduits are widely used across numerous industries, including chemical processing, energy production, semiconductor manufacturing, pharmaceutical processing, food and beverage production, and water treatment. In many such applications, it is desirable or necessary to modify the surface characteristics of the inner wall of a pipe. For example, surface treatment processes such as etching, cleaning, activation, texturing, or conditioning may be performed to prepare the surface for subsequent processing steps, including coating, bonding, welding, brazing, sealing, or joining operations.

Conventional techniques for treating the interior surfaces of pipes often involve introducing a processing fluid, such as a chemical etchant or cleaning solution, into the pipe and allowing the fluid to flow along a length of the pipe. While such approaches can be effective for treating large regions, they are generally inefficient or impractical when treatment is required only in a localized region of the pipe. In particular, it can be difficult to confine the processing fluid to a precisely defined area of the inner surface, which may result in over-processing, under-processing, excessive chemical consumption, extended processing times, and unintended damage to untreated regions.

In many applications, localized surface treatment is especially important in regions associated with joints, welds, fittings, couplings, or connection interfaces. In these situations, precise control over the location and extent of surface modification is critical to achieving reliable mechanical integrity, fluid sealing, and long-term durability. However, existing devices and methods for interior pipe treatment typically lack the ability to isolate and control fluid flow to a restricted region of the inner surface with sufficient precision and repeatability.

Some known approaches rely on masking, mechanical plugs, inflatable bladders, or temporary barriers to block portions of the pipe. These techniques often suffer from limitations including complex installation procedures, poor sealing performance, susceptibility to leakage, limited compatibility with different pipe diameters and materials, and difficulty maintaining consistent fluid pressure and flow distribution within the targeted region. As a result, achieving uniform and reproducible etching or surface treatment within a confined section of a pipe remains a significant technical challenge.

Accordingly, there exists a need for improved devices and methods that enable controlled delivery of processing fluids to a localized region of an inner surface of a pipe, while effectively isolating adjacent regions from exposure. Such devices would preferably provide reliable sealing, uniform fluid distribution, adaptability to a range of pipe sizes and materials, and ease of installation and removal, thereby enabling precise, efficient, and repeatable surface treatment of interior pipe surfaces.

### BRIEF SUMMARY

The systems and methods of the present disclosure address these challenges by providing a fluid isolation device configured to confine the flow of a fluid or gas within an inner region of a pipe near its end. The device seals against the outer circumferential surface of the pipe at or near the pipe end and against the inner circumferential surface spaced apart from the end, creating an enclosed region that can be exposed to a fluid, such as an etching, cleaning, or rinsing agent, or a gas, such as an inert gas used to purge residual fluids. The dimensions of the device may determine both the longitudinal length of the exposed region and the range of pipe diameters on which the device can be used.

Accordingly, the present disclosure provides a fluid isolation device comprising a flow tube positioned along a longitudinal axis of the device and having an open first end, a closed second end, and radially positioned apertures; and a support cage having axially separated top and bottom flow plates, wherein the bottom flow plate is spaced apart from the second end of the flow tube.

The device further comprises a compression nut threadedly connectable over a locking knob. The compression nut includes flow channels in fluid communication with apertures in the top flow plate that provide fluid communication with a fluid outlet. When the device is inserted into a pipe end so that the compression nut and locking knob are positioned over an end of the pipe, the locking knob may be threaded into the compression nut to compress an outer gasket positioned therebetween to seal the device about an outer circumference of the pipe at an end thereof.

According to certain aspects, the device comprises a cap having cap flow channels and the fluid outlet. The cap may be attached to the compression nut via a set of bolts that pass through bores in the cap to openings in the compression nut.

According to certain aspects, the device comprises an anchor nut that is threadedly connectable about an outer circumference of the flow tube and adjacent to the open first end thereof. Screwing the anchor nut into the flow tube pulls the second end of the flow tube toward the anchor nut such that an inner gasket positioned between the second end of the flow tube and the bottom flow plate is compressed and seals against an inner surface of the pipe. This creates an enclosed region within the pipe at the end thereof that may be exposed to fluids of a user’s choice, such as etching, cleaning, or rinsing fluids, or gases, such as an inert gas used to purge residual fluids (i.e., drying the surfaces).

According to certain aspects of the device, the second end of the flow tube comprises a stop plate sized and shaped to fit within the pipe end and support the inner gasket. As such, screwing the anchor nut into the flow tube pulls the stop plate of the flow tube toward the anchor nut such that an inner gasket positioned between the stop plate and the bottom flow plate is compressed and seals against an inner surface of the pipe.

As disclosed, the device may be configured to accept a flow of a fluid (1) in through the open first end of the flow tube, (2) out through the apertures in the flow tube, (3) up through the flow channels of the compression nut to the cap flow channels, and (4) out through the fluid outlet.

According to certain aspects of the device, the apertures in the flow tube are proximate the second closed end thereof.

According to certain aspects of the device, the top and bottom flow plates of the support cage may be connected to each other via longitudinal supports, such as three or more longitudinal supports, wherein the supports are perpendicularly connected to the top and bottom flow plates.

According to certain aspects, the device may comprise an inner ring gasket configured to seal the compression nut against an outer surface of the flow tube and an outer ring gasket configured to seal the compression nut against a top edge of the pipe end.

According to certain aspects of the device, the bottom flow plate may include apertures.

The present disclosure further provides a method for isolating a fluid flow within an inner region of a pipe. The method generally comprises (i) positioning the stop plate of any one of the fluid isolation devices disclosed herein into an open end of a cylindrical pipe until an inner surface of the compression nut of the device contacts a rim of the open end of the pipe, (ii) threadedly connecting the locking knob of the device into the compression nut of the device to seal the outer gasket against an outer circumferential surface of the pipe, (iii) threadedly connecting the anchor nut of the device onto the flow pipe of the device to seal the inner gasket against the inner circumferential surface of the pipe, and (iv) supplying a fluid to the open first end of the flow tube of the device and collecting the fluid from the fluid outlet of the cap of the device.

The fluid may be supplied to the device under pressure and/or may be recirculated through the device. Moreover, the steps of (i) threadedly connecting the locking knob of the device into the compression nut of the device, and (ii) threadedly connecting the anchor nut of the device onto the flow pipe of the device, can be performed in either order.

### BRIEF DESCRIPTION OF THE DRAWINGS

Aspects, features, benefits, and advantages of the embodiments herein will be apparent with regard to the following description, appended claims, and accompanying drawings. In the following figures, like numerals represent like features in the various views. It is to be noted that features and components in these drawings, illustrating the views of embodiments of the presently disclosed invention, unless stated to be otherwise, are not necessarily drawn to scale. The present invention described herein may be better understood by reference to the accompanying drawing sheets, in which:

FIG. 1 illustrates a perspective view of a fluid isolation device for isolating a fluid flow on an inside surface of a pipe end according to aspects of the present disclosure.

FIG. 2 illustrates an environmental perspective view of the device shown in FIG. 1 in use within a cylindrical pipe.

FIG. 3 illustrates an exploded view of various components of the device shown in FIG. 1.

FIG. 4 illustrates a cross-sectional view of the device as shown in FIG. 2.

FIG. 5 illustrates the device as shown in FIG. 2 with certain components illustrated as transparent.

FIG. 6 illustrates the device as shown in FIG. 1 with certain components illustrated as transparent.

FIG. 7 illustrates a cross-sectional view of the device shown in FIG. 1.

### DETAILED DESCRIPTION

The present disclosure provides various alternative aspects and implementations of a fluid isolation device configured to provide a flow of fluid in an isolated region of a pipe end. The device may be used to circulate fluids, such as etching fluids (e.g., acidic or basic etching fluids), cleaning fluids, rinsing fluids, and even gases (e.g., inert gases). Moreover, methods of use of the device may provide alternating circulation of the various fluids.

Before providing a detailed description of the devices and methods of the present disclosure, certain definitions and abbreviations are provided to enhance the reader’s understanding of the disclosed invention.

### Definitions and Abbreviations

Various aspects of the devices and methods of use thereof provided in this disclosure may be illustrated by describing components that are coupled, attached, and/or joined together. As used herein, the terms “coupled,” “attached,” and/or “joined” are interchangeably used to indicate either a direct connection between two components or, where appropriate, an indirect connection to one another through intervening or intermediate components. In contrast, when a component is referred to as being “directly coupled,” “directly attached,” and/or “directly joined” to another component, there are no intervening elements shown in said examples.

Various aspects of the devices and methods of use thereof disclosed herein may be illustrated with reference to one or more exemplary implementations. As used herein, the term “exemplary” means “serving as an example, instance, or illustration,” and should not necessarily be construed as preferred or advantageous over other variations of the systems, devices, and methods disclosed herein. “Optional” or “optionally” means that the subsequently described component, event, or circumstance may or may not be included or occur, and the description encompasses instances where the component or event is included and instances where it is not.

Furthermore, throughout the specification, reference to “one aspect,” “an aspect,” or “some aspects” means that a particular described feature, structure, or characteristic is included in at least one embodiment, configuration, or version of the device or methods of use thereof. Thus, appearances of the phrases “in one aspect,” “in an aspect,” or “in some aspects” in various places throughout this specification are not necessarily all referring to the same embodiment. Those skilled in the art will recognize that the various embodiments can be practiced without one or more of the specific details or with other methods, components, materials, etc. In other instances, well-known structures, materials, or operations are not shown or not described in detail to avoid obscuring aspects of the embodiments.

Certain terminology is used in the following description for convenience only and is not limiting. The words “lower,” “upper,” “bottom,” “top,” “front,” “back,” “left,” “right” and “sides” designate directions in the drawings to which reference is made but are not limiting with respect to the orientation in which the various parts of the systems and devices disclosed herein may be used unless otherwise indicated.

It must also be noted that as used herein and in the appended claims, the singular forms “a,” “an,” and “the” include the plural reference unless the context clearly dictates otherwise. Thus, reference to “a” gasket, “an” aperture, or “the” fluid may include reference to one or more of these elements. Unless defined otherwise, all technical and scientific terms used herein have the same meaning as commonly understood by one of ordinary skill in the art.

As used herein, the term “fluid” should be understood to refer to both liquids and gases. Exemplary fluids may include etching compositions, cleaning or rinsing solutions, and gases, such as inert gases used for drying the pipe in the exposed region.

All numerical quantities stated herein are approximate, unless indicated otherwise, and are to be understood as being prefaced and modified in all instances by the term “about.” The numerical quantities disclosed herein are to be understood as not being strictly limited to the exact numerical values recited. Instead, unless indicated otherwise, each numerical value included in this disclosure is intended to mean both the recited value and a functionally equivalent range surrounding that value.

All numerical ranges recited herein include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value equal to or less than 10.

As generally used herein, the terms “include,” “includes,” and “including” are meant to be non-limiting. As generally used herein, the terms “have,” “has,” and “having” are meant to be non-limiting.

### Aspects and Embodiments of the Present Disclosure

Disclosed herein is a fluid isolation device configured to provide fluid flow within a defined region at the end of a pipe. The device seals about the outer surface near the open end of the pipe and the inner surface distal from the open end, creating an enclosed region that can be selectively exposed to fluids.

As an example, the pipe may be a cylindrical titanium tube. Titanium is valued for its strength, corrosion resistance, and biocompatibility, but its naturally forming titanium dioxide layer can make adhesion to other materials, or even to titanium itself, difficult. Conventional bonding methods such as welding or mechanical surface treatments can be unreliable, require precise control, or risk damaging the material. Achieving strong adhesion is particularly challenging when joining a carbon fiber pipe to the inner surface of a titanium pipe or bonding two titanium pipes. The devices disclosed herein may be used to isolate a region at the end of the titanium pipe and enable circulation of an etching fluid through the enclosed region, facilitating etching or surface treatment of the inner circumference that would enable adhesion to the etched region, e.g., connection to other pipes, adhesion of coatings, etc. Exemplary etching processes and fluids useful for titanium and other metals are disclosed in U.S. Patents 11,952,523; 11,851,772; 11,952,669; 11,932,947; and 11,059,595.

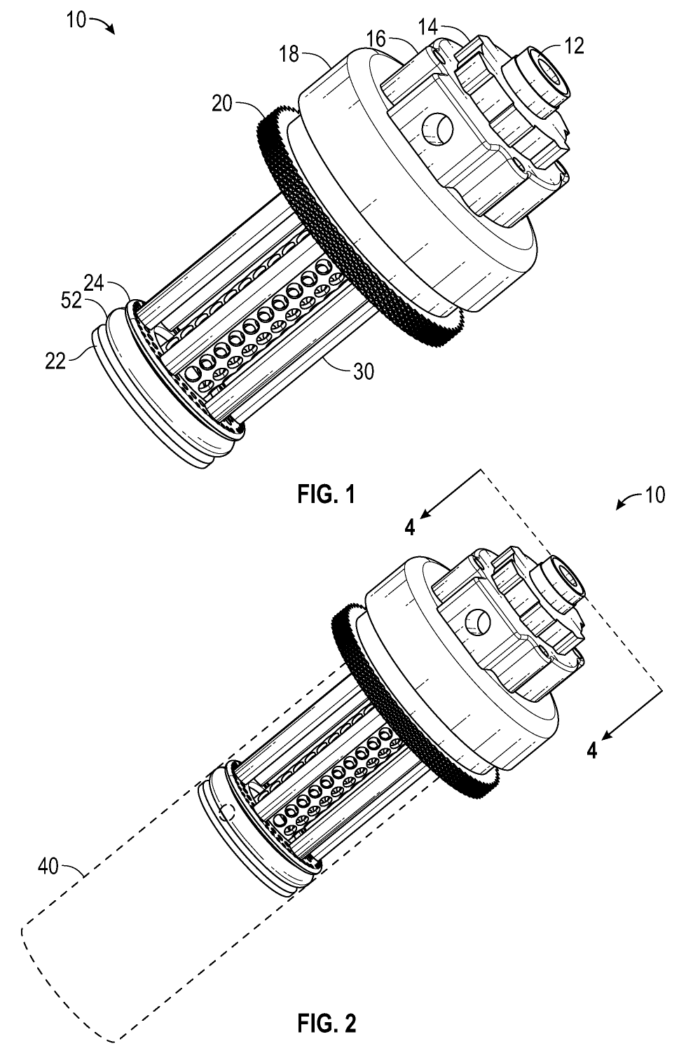

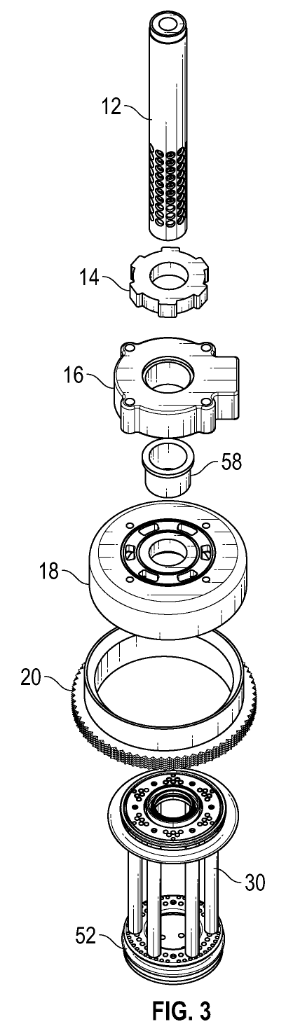

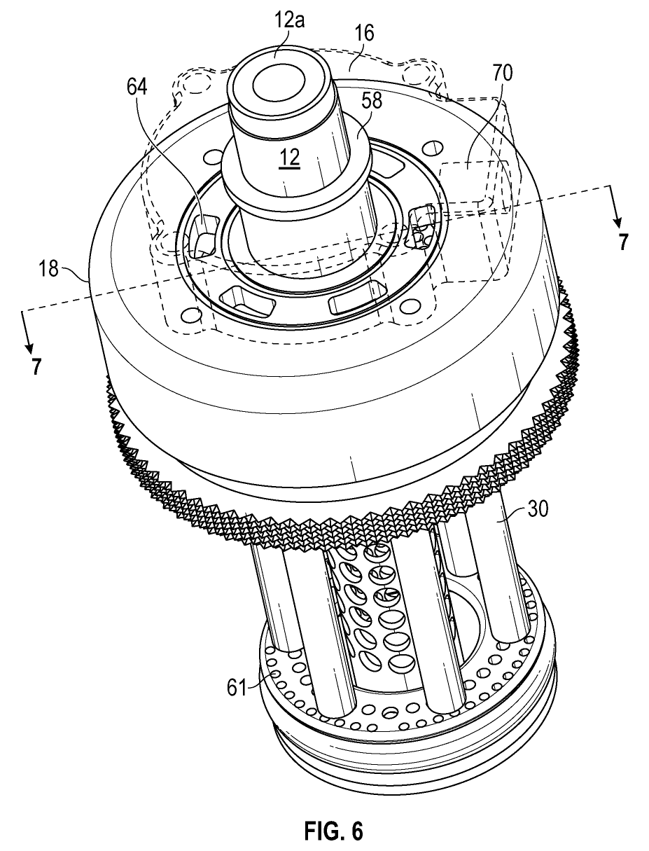

The devices and methods of the present disclosure will now be described with reference to FIGS. 1-7. When installed within an end of a pipe, the fluid isolation device 10 (also referred to as device 10) seals about an open end of a pipe, such as at the open end or along an outer circumference of the pipe adjacent to open end, and also seals about an inner circumference of the pipe at a position separated from the open end of the pipe. As such, the device creates an enclosed region on an inside of the pipe near an end thereof. Fluids, e.g., liquids and/or gases, may be supplied to the enclosed region and/or circulated through the enclosed region.

When installed in an open end of a pipe, the device 10 provides a flow path that includes entry of fluids in through an inlet (see flow direction designated by arrow 90), out through apertures in a flow tube (see flow direction designated by arrow 92), back up toward the end of the pipe through a space created inside the pipe by the device (see flow direction designated by arrow 94), and out through a fluid outlet (see flow direction designated by arrow 96).

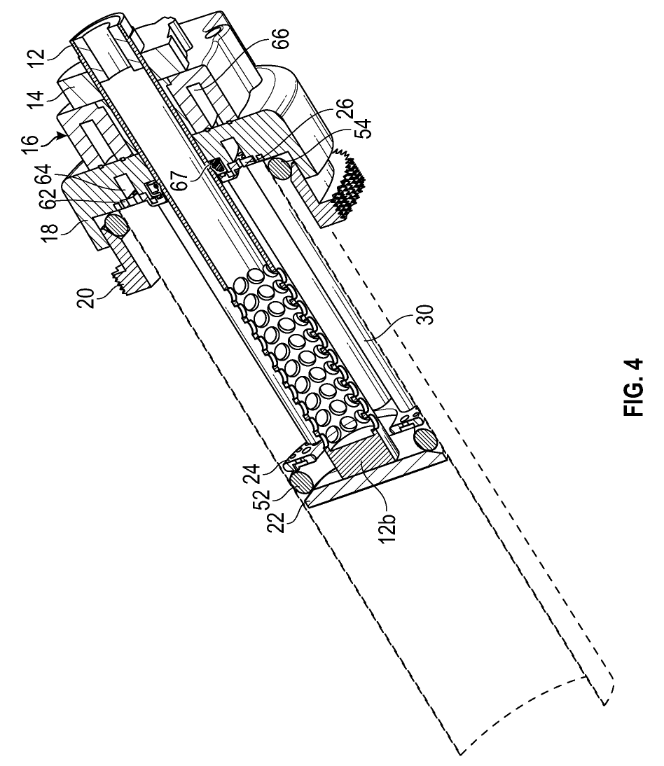

The device 10 generally includes a flow tube 12 positioned along a longitudinal axis of the device (see arrow 90) having an open first end 12a and a closed second end 12b. A plurality of radially positioned apertures 12c may be included along all or only a portion of the length of the flow tube 12. For example, as shown in FIG. 4, the apertures 12c are included in a lower portion of the flow tube 12, such as proximate to the second end 12b thereof.

The device further includes a support cage having top and bottom flow plates (26 and 24, respectively) that are axially separated by at least two supports 30. The first end of each support 30 is attached perpendicularly to the top flow plate 26 and a second end support 30 is attached perpendicularly to the bottom flow plate 24. In general, two or more supports are attached to and separate the top and bottom flow plates, such as three, four, five, six, or more supports. In one example, and as shown in the figures, six supports 30 are included to secure and provide separation between the top and bottom flow plates.

The supports 30 may be attached to the top and bottom flow plates (26 and 24, respectively) via screws or bolts, welding, adhesives, and the like, or the top and bottom flow plates and the supports may be formed as a one-piece construction, such as via 3D-printing, molding, etc. When the device is intended for use with strong chemicals, such as etching solutions, the various portions may be bolted or screwed together, welded, or formed as one-piece construction (i.e., adhesives may not be used in those cases). The supports may be attached to the flow plates at positions radially spaced apart from a central longitudinal axis and may be equidistant from each other. As such, the supports 30 may be spaced apart from and encircle the flow tube 12, which is positioned along the longitudinal axis of the device. Each of the top and bottom flow plates (26 and 24, respectively) may include a central aperture sized and shaped to provide passage of the flow tube 12 therethrough. Accordingly, the flow tube 12 may pass through a center of the cage that is defined by the top and bottom flow plates (26 and 24, respectively) that are axially separated by the supports 30, and may extend beyond each of the top and bottom flow plates (see FIG. 4).

In the assembled device, the bottom flow plate 24 is spaced apart from the second end 12b of the flow tube 12 and is closer to the top flow plate 26 than the second end 12b of the flow tube 12 is to the top flow plate 26 (i.e., when installed within a pipe, the second end of the flow tube extends further into the pipe than the bottom flow plate). Overall, the dimensions of the region of the pipe that is to be enclosed by the device will depend on the length of the flow tube and the supports.

According to certain aspects, the second end 12b of the flow tube 12 may comprise a region that extends outward, such as a circular plate. The plate, or stop plate 22, may be integral with the flow tube 12 (i.e., formed as a one-piece construction), or may be a separate component attachable to the second end 12b of the flow tube 12, such as via welding, screws, bolts, adhesives, and the like. As mentioned above, when the device is intended for use with strong chemicals, adhesives may not be preferred. The stop plate 22 is sized and shaped to fit within the pipe.

The device further comprises a compression nut 18 threadedly connectable over a locking knob 20, both of which are sized and configured to be positioned over an end of the pipe. The compression nut 18 includes a central aperture sized and shaped to provide passage of the open first end 12a of the flow tube 12 so that at least a portion of the open top end 12a of the flow tube extends beyond the compression nut 18.

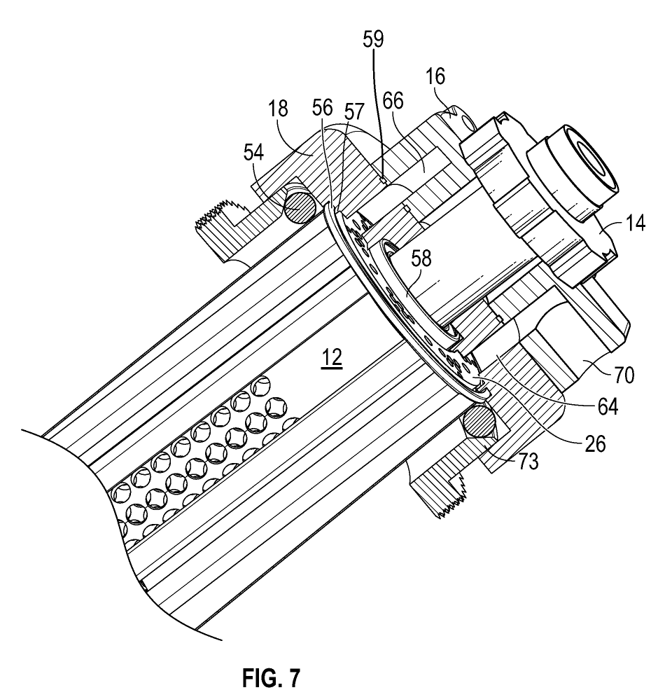

The compression nut 18 includes flow channels 64 in fluid communication with apertures 62 in the top flow plate 26, and which provide fluid communication with a fluid outlet 70. As illustrated in FIGS. 4 and 7, when the device is inserted into a pipe end, screwing the locking knob 20 into the compression nut 18 compresses an outer sealing gasket 54 positioned therebetween to seal the device about an outer circumference of the pipe end. An exemplary region 73 for respective threads on the compression nut 18 and locking knob 20 is shown in FIG. 7.

In some configurations, the bottom flow plate 24 may also include apertures 61. As example, and as shown in FIG. 4, the bottom flow plate 24 includes a central opening or bore that provides passage of the flow tube 12 therethrough. In implementations when the diameter of the opening is larger than the diameter of the flow tube 12, fluid flow could become stagnant if trapped between the bottom flow plate 24 and the stop plate 22. Thus, apertures 61 allow fluid flow to continue through this region.

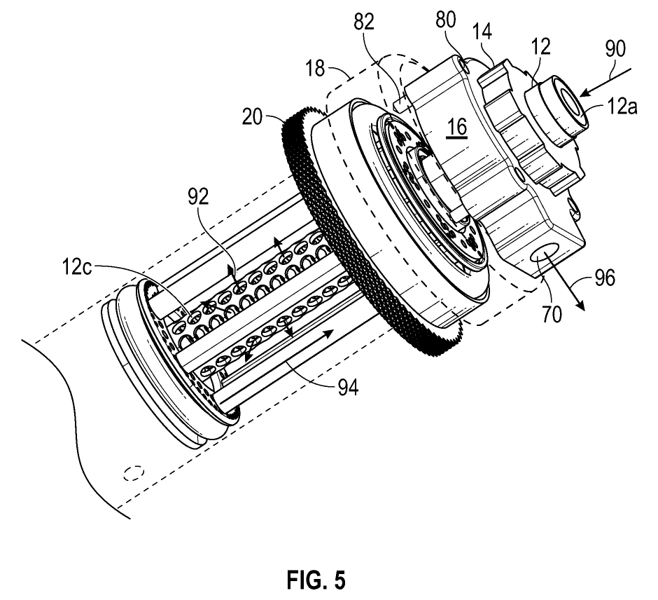

In some configurations, the device may include a cap 16 positioned over and attached to the compression nut 18, such as via bolts, screws, welding, and the like. As illustrated in FIG. 5, the cap 16 may be attached to the compression nut 18 via a set of bolts 82 that pass through bores 80 in the cap to openings in the compression nut. In some configurations of the device, the cap 16 may include the fluid outlet 70 and flow channels (cap flow channels 66) in fluid communication with the fluid outlet 70 (see also FIG. 7).

In some configurations, the flow channels 64 of the compression nut 18 may lead to the fluid outlet such that the cap 16 may not be needed or included.

In some configurations, a ferrule 58 may be included that fits between the flow tube 12 and the cap 16. The ferrule 58 may be included to provide a reliable, leak-tight seal between the cap 16 and the flow tube 12 and to provide structural reinforcement for the flow tube 12.

In certain configurations, the device comprises an anchor nut 14 that is threadedly connectable about an outer circumference of, and adjacent to, the open first end 12a of the flow tube 12. That is, the anchor nut 14 generally fits over an outer circumference of the flow tube 12 proximal to a first end 12a thereof. As such, the anchor nut 14 has a central bore that may include threads configured to connect with corresponding threads on an outer circumference to the flow tube 12. Threadedly attaching the anchor nut 14 onto the flow tube 12 pulls the second end 12b of the flow tube 12 toward the anchor nut 14 such that an inner sealing gasket 52 positioned between the second end 12b of the flow tube 12, i.e., against the stop plate 22, and the bottom flow plate 24 is compressed and seals against an inner surface of the pipe.

Each of the cap 16, when included, and anchor nut 14 include a central aperture sized and shaped to provide passage of the open first end 12a of the flow tube 12, wherein the central apertures of each (i.e., 16, 14) are aligned with the central aperture of the compression nut 18. Thus, in the assembled device, at least a portion of the open top end 12a of the flow tube 12 extends beyond the compression nut 18, cap 16 when included, and anchor nut 14.

Additional gaskets may be included to help seal the device 10 onto a pipe end. For example, an inner ring gasket 67 may be included that is configured to seal the compression nut 18 against an outer surface of the flow tube 12. Further, an outer ring gasket 56 may be included that is configured to seal the compression nut 18 against a top edge or rim of the pipe end.

Additional gaskets may be included to help provide a liquid tight connection between various components of the device 10. For example, one or more gaskets 59 may be included between the cap 16 and the compression nut 18 to provide a liquid tight connection therebetween.

The device may be formed of polymers or metals, wherein selection of the material may depend on the intended use of the device. In certain configurations, components of the device or the entire device may be formed from corrosion-resistant metals, including titanium, stainless steel, aluminum, copper, or nickel-based alloys, and/or chemically resistant polymeric materials, including fluoropolymers, polyolefins, polyamides, polyesters, polyaryletherketones, or combinations thereof. When used for etching, such as with high concentration acids, components of the device or the entire device may be formed from high-performance polymers such as PVDF, PEEK, or PPS; and/or corrosion-resistant metals such as tantalum, zirconium, titanium, stainless steel, or nickel-based alloys, including Hastelloy®, Monel®, or Inconel®.

The sealing elements or gaskets used in the device may be formed from chemically resistant elastomeric or polymeric materials capable of withstanding prolonged exposure to strong acids and aggressive processing fluids. Suitable gasket materials include, but are not limited to, fluoropolymer-based materials such as polytetrafluoroethylene (PTFE), expanded PTFE (ePTFE), and fluorinated ethylene propylene (FEP); perfluoroelastomers (FFKM); fluoroelastomers (FKM); ethylene propylene diene monomer rubber (EPDM); and PTFE-encapsulated elastomers. Such materials provide excellent chemical resistance, low permeability, and reliable sealing performance under a wide range of temperatures and pressures, thereby enabling effective isolation of processing fluids within the enclosed region of the device.

As illustrated in the figures, and when installed in a pipe end, the top flow plate includes apertures 62 that allow fluids expelled from the flow tube 12 via the apertures 12c to circulate in the enclosed region and exit through the apertures 62, through the various flow channels (64, 66), and finally out via the fluid outlet 70.

For example, when the device is installed in a pipe end, a flow of a fluid (arrow 90) may enter through the open first end 12a of the flow tube 12, exit (arrows 92) through the apertures 12c in the flow tube, pass upward toward the top flow plate 26 (arrows 94) to pass through apertures 62 in the top flow plate 26, enter the flow channels 64 of the compression nut 18 and the flow channel 66 of the cap 16, and exit (arrow 96) through the fluid outlet 70.

The fluid may be pumped through the device, such as using any pump known in the art. The fluids may be collected and/or recirculated. The fluids may be supplied to the device at elevated pressures and/or temperatures. According to certain aspects, when the fluids are an etching fluid, the flow rate and/or temperature may be controlled to control the level of etching. Multiple different fluids may be provided to the device from a manifold, which may alternate between different etching/cleaning solutions, rinsing, and/or inert gas to purge residual solution from the inner region of the pipe that is isolated by the device.

In methods of use, the devices disclosed herein may be secured to an end of a pipe to provide an isolated region on an inside thereof by first positioning a bottom end of the device, i.e., the stop plate 22, into an open end of a pipe until an inner surface 57 or ridge of the compression nut 18 contacts the rim of the open end of the pipe. When a gasket 56 is included, such as within the inner surface 57 or ridge, the rim of the open end of the pipe would be positioned against the gasket 56 to improve the fluid tight seal about the open end of the pipe The top end of the device (18, 20) may be secured about a circumferential exterior surface at the pipe end by threadedly connecting the locking knob 20 into the compression nut 18 to seal the outer sealing gasket 54 against an outer circumferential surface of the pipe. The bottom end of the device, e.g., stop plate 22, may be secured to an inner circumferential surface of the pipe by threadedly connecting the anchor nut 14 onto the flow tube 12, thus pulling the stop plate 22 closer to the bottom flow plate 24 and compressing the inner sealing gasket 52 against the inner circumferential surface of the pipe. The top and bottom of the device may be secured to the pipe in any order, i.e., compress either the outer gasket or the inner gasket first.

The devices disclosed herein may be used to isolate a region at a pipe end and enable circulation of a fluid through the enclosed region. As such, the devices disclosed herein may be used to etch an inner circumference of a pipe end. An exemplary method includes securing the device to the pipe end as described hereinabove and supplying an etching fluid to the open first end 12a of the flow tube 12 and collecting the etching fluid from the fluid outlet 70 of the cap 16. As mentioned above, the etching fluid may be supplied to the device under elevated temperature and/or elevated pressure, such as via a pump, and may be recirculated through the device.

### REFERENCE NUMBERS USED IN THE DESCRIPTION AND DRAWINGS

10 fluid isolation device

12 flow tube

12a open first end of the flow tube 12

12b closed second end of the flow tube 12

12c apertures in the flow tube 12

14 anchor nut

16 cap

18 compression nut

20 locking knob

22 stop plate of the flow tube 12

24 bottom flow plate

26 top flow plate

30 support

40 cylindrical pipe

52 inner sealing gasket

54 outer sealing gasket

56 outer ring gasket

57 inner surface of the compression nut 18

58 ferrule

59 gasket

61 apertures in the bottom flow plate

62 apertures in the top flow plate

64 flow channel in the compression nut 18

66 flow channel in the cap 16

67 inner ring gasket

70 fluid outlet

73 threaded region of locking knob 20

80 pass through bore such as bolt hole

82 bolt configured to be accepted through bore 80

90-96 direction of fluid flow through the fluid isolation device 10

While particular embodiments have been illustrated and described, it would be obvious to those skilled in the art that various other changes and modifications may be made without departing from the spirit and scope of the invention. Those skilled in the art will recognize or be able to ascertain using no more than routine experimentation, numerous equivalents to the specific apparatuses and methods described herein, including alternatives, variants, additions, deletions, modifications, and substitutions. This application, including the appended claims, is therefore intended to cover all such changes and modifications that are within the scope of this application.

What is claimed is:

1. A device for isolating a flow of fluid inside a pipe, the device comprising:
a flow tube positioned along a longitudinal axis of the device having an open first end, a closed second end, and radially positioned apertures;
a support cage having axially separated top and bottom flow plates, wherein the bottom flow plate is spaced apart from the second end of the flow tube; and
a compression nut threadedly connectable over a locking knob and configured to be positioned over an open end of the pipe;
wherein the compression nut includes flow channels in fluid communication with apertures in the top flow plate, and which provide fluid communication with a fluid outlet,
wherein, when the device is inserted into the open end of the pipe, screwing the locking knob into the compression nut compresses an outer gasket positioned therebetween to seal the device about an outer circumference of the pipe.

2. The device of claim 1, comprising a cap having cap flow channels and the fluid outlet.

3. The device of claim 2, wherein the cap is attached to the compression nut via a set of bolts that pass through bores in the cap to openings in the compression nut.

4. The device of claim 2, comprising an anchor nut that is threadedly connectable about an outer circumference of the flow tube adjacent to the open first end thereof.

5. The device of claim 4, wherein threadedly connecting the anchor nut onto the flow tube pulls the second end of the flow tube toward the anchor nut such that an inner gasket positioned between the second end of the flow tube and the bottom flow plate is compressed and seals against an inner surface of the pipe.

6. The device of claim 2, configured to accept a flow of a fluid through the open first end of the flow tube, out through the apertures in the flow tube, up through the flow channels of the compression nut to the cap flow channels, and out through the fluid outlet.

7. The device of claim 1, wherein the apertures in the flow tube are proximate the second closed end of the flow tube.

8. The device of claim 1, wherein the second end of the flow tube comprises a stop plate sized and shaped to fit within the open end of the pipe and support the inner gasket.

9. The device of claim 1, comprising three or more longitudinal supports connecting the top and bottom flow plates.

10. The device of claim 1, comprising an inner ring gasket configured to seal the compression nut against an outer surface of the flow tube and an outer ring gasket configured to seal the compression nut against a top edge of the open end of the pipe.

11. The device of claim 1, wherein the bottom flow plate includes apertures.

12. A device for isolating a flow of fluid inside an open end of a pipe, the device comprising:
a flow tube positioned along a longitudinal axis of the device, the flow tube having an open first end, a closed second end, an inner longitudinal bore, and a plurality of apertures adjacent the second end, wherein the closed second end of the flow tube comprises a stop plate configured to fit within the pipe;
a support cage comprising a top flow plate axially spaced apart from a bottom flow plate, and three or more longitudinal supports connected therebetween, wherein the supports are radially spaced about the longitudinal axis of the device and set apart from the flow tube, wherein each of the top and bottom flow plates include radially positioned apertures;
a compression nut threadedly connectable over a locking knob and configured to be positioned over the open end of the pipe;
a cap adjacent the open first end of the inner flow tube and having a fluid outlet; and
an anchor nut threadedly connectable about an outer circumference of the flow tube and adjacent to the open first end thereof,
wherein each of the compression nut and cap include flow channels in fluid communication with the apertures in the top flow plate, and which provide fluid communication with the fluid outlet,
wherein, when the device is inserted into the open end of the pipe:
(i) threadedly connecting the locking knob onto the compression nut compresses an outer gasket positioned therebetween, thus sealing the device about an outer circumference of the open end of the pipe, and
(ii) threadedly connecting the anchor nut onto the flow tube pulls the stop plate toward the anchor nut such that an inner gasket positioned between the stop plate and the bottom flow plate is compressed and seals against an inner surface of the pipe.

13. The device of claim 12, wherein the device is configured to accept a flow of a fluid through the open first end of the flow tube, out through the apertures in the flow tube, up through the flow channels of the compression nut to the cap flow channels, and out through the fluid outlet.

14. The device of claim 12, wherein the cap is attached to the compression nut via a set of bolts that pass through bores in the cap to the compression nut.

15. The device of claim 12, wherein the apertures in the flow tube are proximate the second closed end thereof.

16. The device of claim 12, comprising an inner ring gasket configured to seal the compression nut against an outer surface of the flow tube and an outer ring gasket configured to seal the compression nut against a top edge of the open end of the pipe.

17. The device of claim 12, wherein the bottom flow plate includes apertures.

18. A method of etching an inner circumferential surface of a pipe, the method comprising:
positioning the stop plate of a fluid isolation device according to claim 14 into an open end of a cylindrical pipe until an inner surface of the compression nut of the device contacts a rim of the open end of the pipe;
threadedly connecting the locking knob of the device into the compression nut of the device to seal the outer gasket against an outer circumferential surface of the pipe;
threadedly connecting the anchor nut of the device onto the flow pipe of the device to seal the inner gasket against the inner circumferential surface of the pipe; and
supplying an etching fluid to the open first end of the flow tube of the device and collecting the etching fluid from the fluid outlet of the cap of the device.

19. The method of claim 17, wherein the steps of (i) threadedly connecting the locking knob of the device into the compression nut of the device, and (ii) threadedly connecting the anchor nut of the device onto the flow pipe of the device, can be performed in either order.

20. The method of claim 17, wherein the etching fluid is supplied to the device under pressure, the etching fluid is recirculated through the device, or both.
